(19) United States
(12) Patent Application Publication
(10) Pub. No.: US 2011/0249943 A1
(43) Pub. Date: Oct. 13, 2011

(54) GENDER-NEUTRAL MPO CONNECTORS

(76) Inventors: Richard L. Case, Omaha, NE (US); Joseph C. Livingston, Frisco, TX (US)

(21) Appl. No.: 13/086,195

(22) Filed: Apr. 13, 2011

Related U.S. Application Data
(60) Provisional application No. 61/323,583, filed on Apr. 13, 2010.

(51) Int. Cl. G02B 6/38; G02B 6/36

(52) U.S. Cl. 385/59; 385/78

(57) ABSTRACT

A genderless fiber optic connection system includes an MPO cable or cord having at least one genderless MPO connector disposed at one end. The genderless MPO connector includes a housing and a first genderless MPO ferrule attached therein. A mating, front face of the MPO ferrule includes an alignment pin extending therefrom and an alignment hole formed into the front face. Fiber ends are located in one or more rows between the alignment pin and the alignment hole. The connection system may also include a genderless MPO port having a complementary alignment pin, alignment hole, and fiber ends for mating with the genderless MPO connector.

This application claims the benefit of U.S. Provisional Application No. 61/323,583, filed Apr. 13, 2010, the entire contents of which are herein incorporated by reference.

### BACKGROUND OF THE INVENTION

1. Field of the Invention

The present invention relates to MPO connectors and ports. More particularly, the present invention relates to MPO connectors at the ends of MPO patch cords or cables, to attach one MPO cord to another MPO cord or port, and relates to MPO ports for accepting such connectors.

2. Description of the Related Art

Cord and cables with multiple-fiber push-on/pull-off (MPO) connectors are generally known in the art. Such connectors relate to IEC-61754-7 and EIA/TIA 604-5 (FOCIS 5) standards, which are incorporated herein by reference. MPO patch cords have MPO connectors that typically exist in two genders—male with alignment pins or female without alignment pins.

In FIG. 1, reference numeral 11 denotes a male MPO connector, in accordance with the prior art. In initial construction, the male MPO connector 11 has first and second holes 13 and 15 formed in a termination end or front face 17 of a first ferrule 18. First and second alignment pins 19 and 21 reside within the first and second holes 13 and 15, respectively, and protrude away from the front face 17 of the first ferrule 18.

Fiber ends 23 are located in a single row and are aligned between the first and second alignment pins 19 and 21. Although FIG. 1 illustrates eight fiber ends 23 located between the first and second alignment pins 19 and 21, it is known to have twelve fiber ends in a single row, twenty-four fiber ends in two rows, forty-eight fiber ends in four rows, or seventy-two fiber ends in six rows between the first and second alignment pins 19 and 21.

FIG. 2 illustrates a pin clamp 25, which is assembled into the male MPO connector 11. The pin clamp 25 holds ends of the first and second alignment pins 19 and 21, so that the first and second alignment pins 19 and 21 are well anchored within the front face 17 of the ferrule 18 and not easily removed from the male MPO connector 11 during mating of the male MPO connector 11 with a female MPO connector or during mating with a female MPO port.

In FIG. 3, reference numeral 27 denotes a female MPO connector, in accordance with the prior art. The female MPO connector 27 has third and fourth holes 29 and 31 formed in a termination end or front face 33 of a second ferrule 35. The third and fourth holes 29 and 31 are empty and do not possess any alignment pins. Rather, the third and fourth holes 29 and 31 are provided as guidance holes to receive the first and second alignment pins 19 and 21 of a mating male MPO connector 11 or mating male MPO port.

Fiber ends 37 are located in a single row and are aligned between the third and fourth holes 29 and 31. Although FIG. 3 illustrates eight fiber ends 37 located between the third and fourth holes 29 and 31, it is known to have twelve fiber ends in a single row, twenty-four fiber ends in two rows, forty-eight fiber ends in four rows, or seventy-two fiber ends in six rows between the third and fourth holes 29 and 31.

FIG. 4 illustrates a spacer clamp 39, which is assembled into the female MPO connector 27. The spacer clamp 39 has dimensions similar to the pin clamp 25 of FIG. 2. The spacer clamp 39 may assist in manufacturing the female MPO connector 27, such that the female MPO connector 27 may be manufactured using process steps and equipment similar to the process steps and equipment used to manufacture the male MPO connectors 11, except that the step of inserting the first and second alignment pins 19 and 21 is omitted.

In accordance with the prior art, it can be seen that a female MPO connector 27 cannot be mated to another female MPO connector 27 or female MPO port accurately. Female MPO connectors 27 have only guidance holes 29 and 31. Alignment pins are not associated with female MPO connectors 27 or female MPO ports. Therefore, a precision alignment during mating could not be achieved.

Also in accordance with the prior art, it can be seen that a male MPO connector 11 cannot be mated to another male MPO connector 11. Male MPO connectors 11 have first and second alignment pins 19 and 21. No guidance holes are associated with male MPO connectors 11 or male MPO ports to receive the alignment pins 19 and 21. Therefore, a precision alignment during mating could not be achieved.

In the prior art, an MPO patch cord having a male MPO connector at each end is known. An MPO patch cord having a female MPO connector at each end is known. An MPO patch cord having a male MPO connector at one end and a female MPO connector at the other end is also known. These constitute the three known types of MPO-to-MPO patch cords.

### SUMMARY OF THE INVENTION

The Applicants have appreciated drawbacks with the MPO patch cords, MPO connectors and MPO ports of the background art.

To be fully prepared, a technician must carry a plurality of MPO-to-MPO cords of the three known types to a job site in order to have patch cords for most potential interconnection situations. Most commonly, the technician only carries a plurality of MPO patch cords having female MPO connectors at both ends (e.g., a female-to-female MPO trunk cord), because a female-to-female MPO trunk cord is typically required in most situations where two components of equipment, each having a male MPO port, are to be connected. Therefore, if the female-to-female MPO cord is too short to reach between the two components, the technician has no way to solve the problem, since as discussed above, the technician cannot mate the female MPO connector of a first MPO cord to the female MPO connector of a second MPO cord in order to increase the connection length of the overall cordage to reach between the two components having male MPO ports. Rather, the project has to be put on hold while a female-to-male MPO cord is retrieved from a supply area or ordered from a supply house.

It is an object of the present invention to address this drawback associated with the MPO patch cords of the background art.

These and other objects are accomplished by an MPO patch cord comprising fiber optic cordage, and a genderless MPO connector disposed at one end of said cordage.

Further, these and other objects are accomplished by a genderless MPO connector comprising a housing, and a genderless MPO ferrule attached to said housing.

Moreover, these and other objects are accomplished by a genderless MPO port comprising a housing, and a genderless MPO ferrule attached to said housing.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a front perspective view of a male MPO connector, in accordance with the prior art;

FIG. 2 is a front perspective view of a pin clamp employed within the male MPO connector of FIG. 1;

FIG. 3 is a front perspective view of a female MPO connector, in accordance with the prior art;

FIG. 4 is a front perspective view of a spacer clamp employed within the female MPO connector of FIG. 3;

FIG. 5 is a front perspective view of a genderless MPO connector at an end of a fiber optic cord, in accordance with the present invention;

FIG. 6 is a front perspective view of a pin clamp employed within the genderless MPO connector of FIG. 5;

FIG. 7 is a top view of an MPO patch cord having a genderless MPO connector at a first end and a male MPO connector at a second end;

FIG. 8 is a top view of an MPO patch cord having a genderless MPO connector at a first end and a female MPO connector at a second end;

FIG. 9 is a top view of an MPO patch cord having a first genderless MPO connector at a first end and a second genderless MPO connector at a second end;

FIG. 10 is a top view of an MPO patch cord having a genderless MPO connector at a first end and a fanout of duplex LC connectors at a second end;

FIG. 11 is a front view of a ferrule face of a genderless MPO connector, in accordance with the present invention;

FIG. 12 is a front view of a ferrule face of a genderless MPO port, in accordance with the present invention; and

FIG. 13 is a front perspective view of a mating adapter for aligning a first genderless MPO connector with a second genderless MPO connector.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

FIG. 5 illustrates a genderless MPO connector 41. In initial construction, the genderless MPO connector 41 has first and second holes 43 and 45 formed in a termination side or front face 47 of a first, genderless, MPO ferrule 48. The first ferrule 48 is attached to a housing 50. A first alignment pin 49 resides within the second hole 45 and protrudes away from the front face 47 of the first ferrule 48. The first hole 43 remains empty and does not possess any alignment pin. Rather, the first hole 43 is provided as a guidance hole extending into the first ferrule 48 to receive an alignment pin of a mating genderless MPO connector or mating genderless MPO port.

Fiber ends 53 are located in a single row and are aligned between the first hole 43 and the first alignment pin 49. Although FIG. 5 illustrates eight fiber ends 53 located between the first hole 43 and the first alignment pin 49, other configurations are possible. For example, the fiber ends 53 may include twelve fiber ends in a single row, twenty-four fiber ends in two rows, forty-eight fiber ends in four rows, or seventy-two fiber ends in six rows between the first hole 43 and the first alignment pin 49.

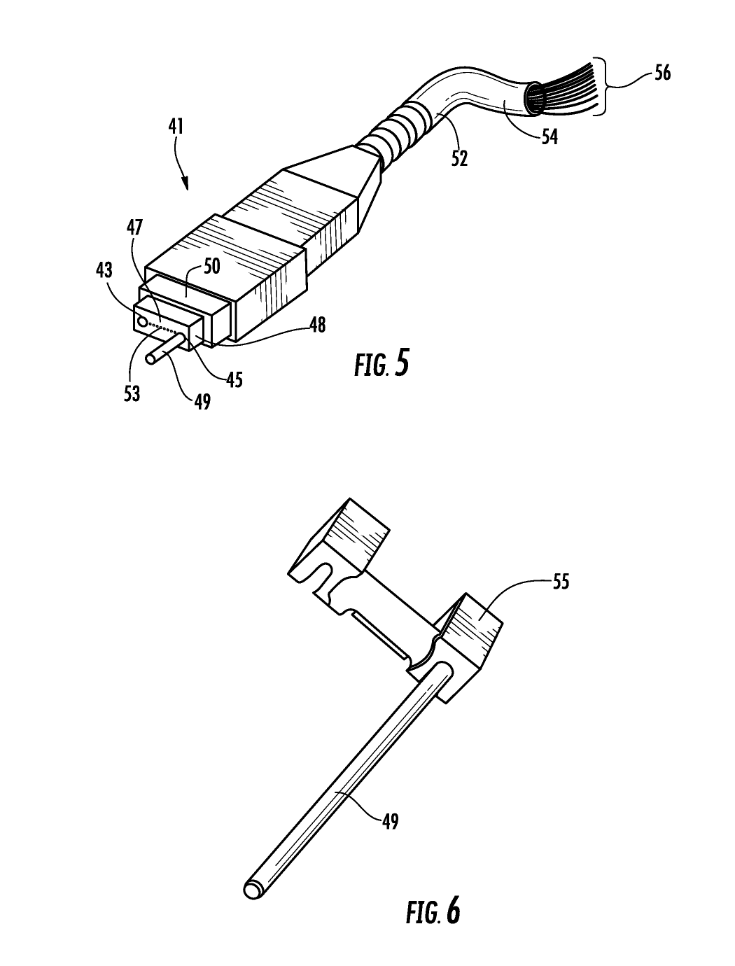

FIG. 6 illustrates a pin clamp 55, which is assembled into the genderless MPO connector 41. The pin clamp 55 holds an end of the first alignment pin 49, so that the first alignment pin 49 is well anchored within the front face 47 of the first ferrule 48 and is not easily removed from the genderless MPO connector 41 during mating of the genderless MPO connector 41 with a genderless MPO connector or during mating with a genderless MPO port.

The termination side or front face 47 of the first ferrule 48 is the side closest to the mating MPO connector or mating MPO port. The front face 47 presents a generally flat ferrule face. A side of the first ferrule 48 opposite to the front face 47 includes a strain relief boot 52. Fibers exiting from the first ferrule 48 on the side opposite to the front face 47 pass through the strain relief boot 52 before entering into fiber optic cordage 54 possessing a plurality of optical fibers 56.

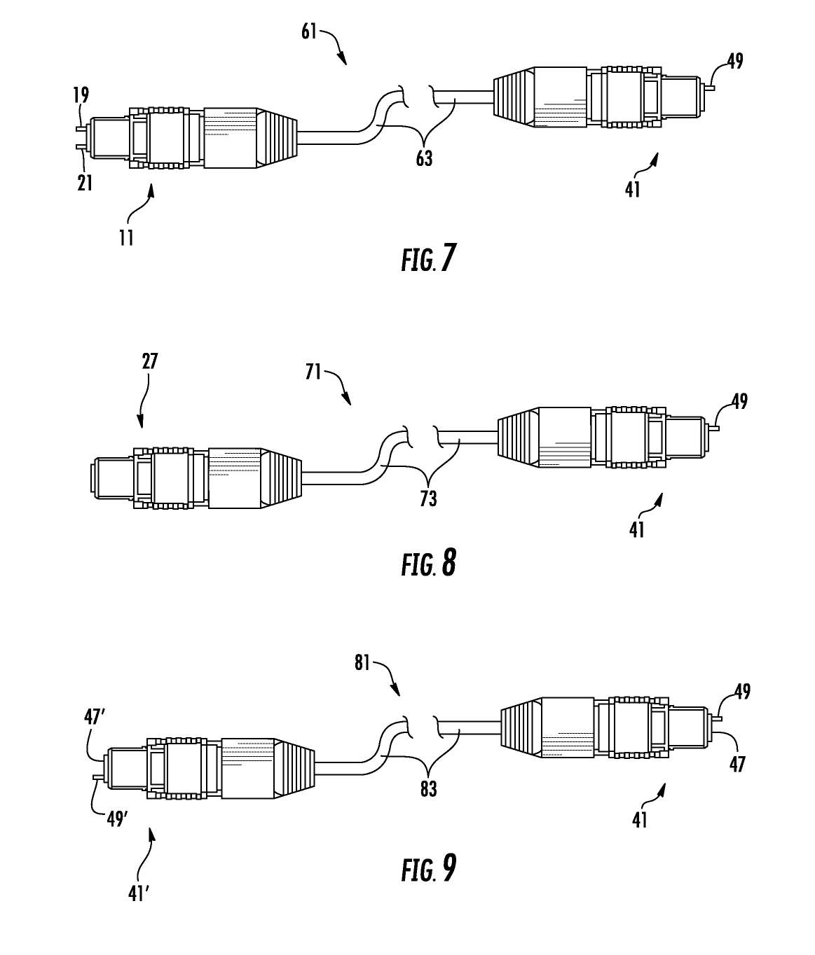

There are several embodiments in the present invention of a genderless MPO patch cord having at least one genderless MPO connector 41, as illustrated in FIG. 5. FIGS. 7-10 illustrate four such genderless MPO patch cords.

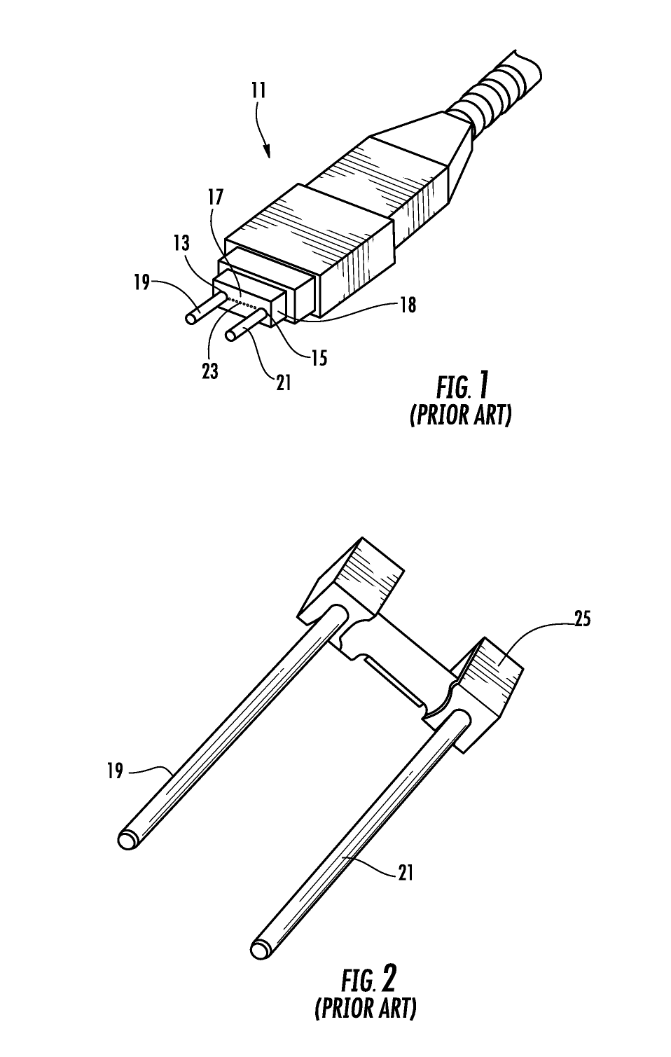

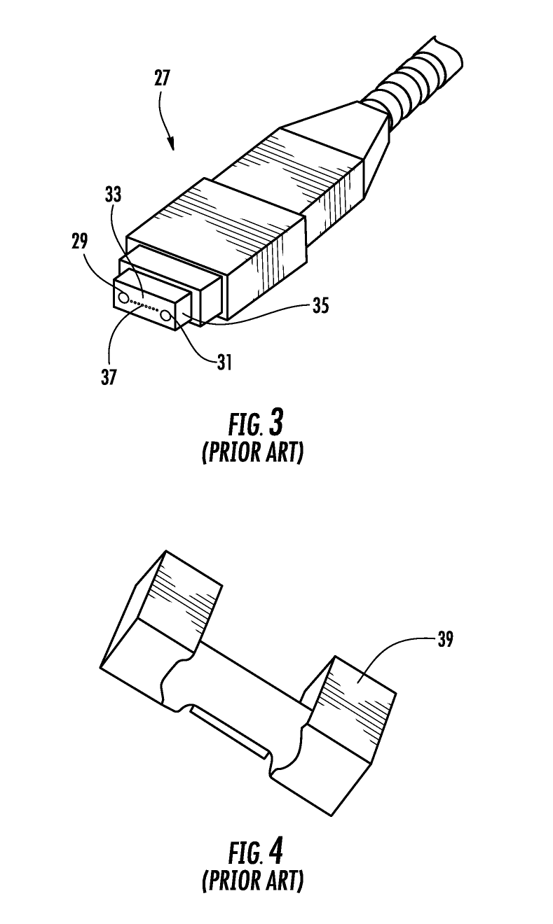

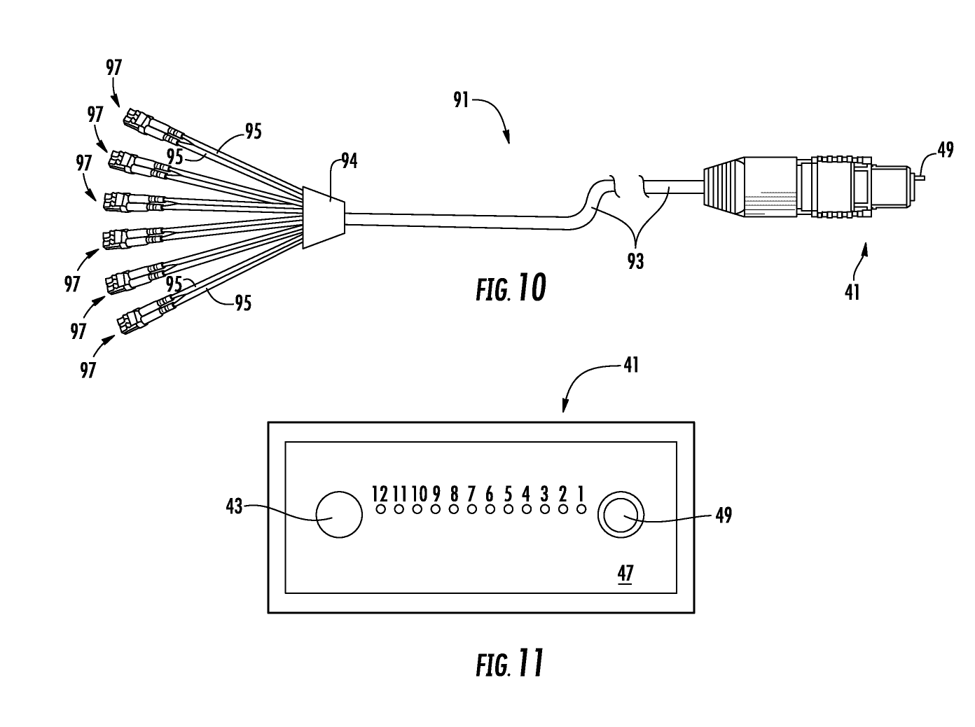

In FIG. 7, a first MPO patch cord 61 includes a genderless MPO connector 41 at a first end of cordage 63 and a male MPO connector 11 (see FIG. 1), having first and second alignment pins 19 and 21, disposed at an opposite end of the cordage 63. In FIG. 8, a second MPO patch cord 71 includes a genderless MPO connector 41 at a first end of cordage 73 and a female MPO connector 27 (see FIG. 3), having first and second guide holes 29 and 31, disposed at an opposite end of the cordage 73. In FIG. 9, a third MPO patch cord 81 includes a first genderless MPO connector 41 at a first end of cordage 83 and a second genderless MPO connector 41′ disposed at an opposite end of the cordage 83. The second genderless MPO connector 41′ may be formed identically to the first genderless MPO connector 41 of FIG. 5.

In FIG. 10, a fourth MPO patch cord 91 includes a first genderless MPO connector 41 at a first end of cordage 93 and a fanout 94 of individual fiber connectors disposed at an opposite end of the cordage 93. The fanout 94, sometimes referred to as a breakout, separates the individual optical fibers within the cordage 93 into multiple jackets 95, which lead to individual fiber connectors. Such individual fiber connectors may be of the LC, SC, FC, MT-RJ and/or ST types, as well as other known types. Also, the individual fiber connectors may be paired up to form duplex connectors, such as the duplex LC type connectors 97 illustrated in FIG. 10.

In one embodiment of the present invention, optic fibers within the cordage 83 of the third patch cord 81 are twisted one hundred eighty degrees between the first genderless MPO connector 41 and the second genderless MPO connector 41′. This embodiment is referred to as a crossover cord. By this arrangement, the fiber end next to the alignment pin 49 on the front face 47 of the first genderless MPO connector 41 ends up next to the alignment pin 49′ on the front face 47′ of the second genderless MPO connector 41′.

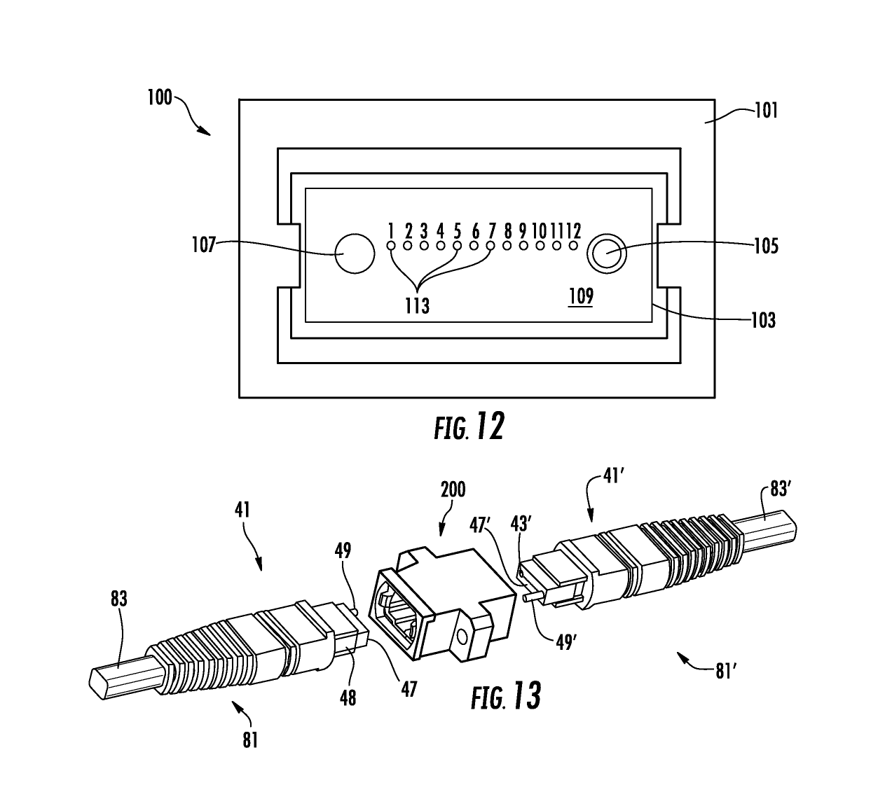

FIG. 11 shows the front face 47 of the first genderless MPO connector 41 with the fiber ends numbered. It can be seen that the number one fiber end is located next to the alignment pin 49 and the twelfth fiber end is located next to the guidance hole 43. The front face 47′ of the second genderless MPO connector 41′ would be identical to the configuration in FIG. 11, with the number one fiber end located next to the alignment pin 49′ and the twelfth fiber end located next to the guide hole 43′.

As seen in FIG. 9, the alignment pin 49 is at the top of the first genderless MPO connector 41, while the alignment pin 49′ is at the bottom of the second genderless MPO connector 41′. Therefore, the optic fibers within the cordage 83 must twist one hundred eighty degrees in order for the number one fiber end at the top of the first genderless MPO connector 41 to find its way to the bottom of the second genderless MPO connector 41′. The twist in the cordage 83 permits the third patch cord 81 to maintain proper fiber orientation when mating to a first genderless MPO port to a second genderless MPO port.

FIG. 12 shows the mating ferrule face 109 of a genderless MPO port 100, in accordance with the present invention. The genderless MPO port 100 includes a housing 101, and a genderless MPO ferrule 103 attached to the housing 101. The genderless MPO ferrule 103 includes one alignment pin 105 for entering the guide hole 43 of a mating genderless MPO connector 41 and one guide hole 107 for receiving the alignment pin 49 of the mating genderless MPO connector 41.

The ferrule face 109 is considered a termination side of the ferrule 103 for mating with the genderless MPO connector 41 as the genderless MPO connector 41 is docked into the genderless MPO port 100. The ferrule face 109 is configured as a generally flat surface. The alignment pin 105 extends away from the ferrule face 109, and the guide hole 107 extends into the ferrule face 109.

A plurality of fiber ends 113 (numbered one through twelve in FIG. 12) terminate at the ferrule face 109 and may be polished. It can be seen that the number one fiber end is located next to the guide hole 107 and the twelfth fiber end is located next to the alignment pin 105. By this arrangement, the number one fiber end of the genderless MPO connector 41 next to the alignment pin 49 will interface with the number one fiber end of the genderless MPO port 100, next to the guide hole 107.

The plurality of fiber ends 113 are located in a single row and are aligned between the guide hole 107 and the alignment pin 105. Although FIG. 12 illustrates twelve fiber ends 113 located between the guide hole 107 and the alignment pin 105, other configurations are possible. For example, the fiber ends 113 may include eight fiber ends in a single row, twenty-four fiber ends in two rows, forty-eight fiber ends in four rows, or seventy-two fiber ends in six rows between the guide hole 107 and the alignment pin 105.

FIG. 13 illustrates a preferred structure for establishing a connection between the genderless MPO patch cord 81 of FIG. 9 and another genderless MPO patch cord 81′, also constructed like FIG. 9. Such a connection may be referred to as a daisy-chain connection between first and second MPO patch cords 81 and 81′.

In FIG. 13, the mating of the genderless MPO connectors 41 and 41′ occurs inside of an MPO alignment adapter 200. The MPO alignment adapter 200 provides initial course alignment prior to the entrance of the guide pins 49, 49′ within the guide holes 43, 43′. The MPO alignment adapter 200 also provides environmental, e.g., dust, protection at the mating faces 47, 47′.

According to the present invention, a technician may carry MPO patch cords 81 with genderless MPO connectors 41, 41′ at each end, and may extend the length of a single patch cord 81 by simply mating a first genderless MPO connector 41 of a first patch cord 81 to a second genderless MPO connector 41′ of a second MPO patch cord 81′, as illustrated in FIG. 13. However, it should be noted that once a first MPO patch cord 81 is daisy-chained to a second MPO patch cord 81′, the fiber orientations will be reversed at the opposite end of the second MPO patch cord 81′. This occurs because the number one fiber end on the first genderless MPO connector 41 (beside the alignment pin 49, interfaces to the number twelve fiber end on the second genderless MPO connector 41′ (beside the guide hole 43′).

In order to have proper fiber orientation between first and second genderless MPO ports 100, the technician would need to daisy-chain MPO patch cords 81 (of the crossover type in FIG. 9) together in odd numbers. Hence, it would be possible to connect a first genderless MPO port 100 to a second genderless MPO port 100′ by a single MPO patch cord 81, by three MPO patch cords 81 daisy-chained together, by five MPO patch cords 81 daisy-chained together, etc.

Alternative, it would be possible to provide a modified MPO patch cord, like the MPO patch cord 81 of FIG. 9, except that the optic fibers within the modified patch cord would not be twisted one hundred eighty degrees within the cordage 83. Such a modified patch cord would be deemed an equipment MPO patch cord (also known as a straight-thru cord), and would maintain the fiber orientation when plugged into the MPO patch cord 81. Such a modified patch cord could be color coded to indicate its different internal structure from the patch cord 81 in FIG. 9, and such a modified patch cord could not be used to connect a first genderless MPO port 100 to a second genderless MPO port 100′ because a direction port-to-port connection using the modified patch cord would reverse the fiber end ordering between the ports. However, the straight-thru cord could be used to connect a first genderless MPO port 100 to a second genderless MPO port 100′, if a polarity correction is built in, which could be done by labeling and corrections on the fanout (FIG. 10) or on ports 100 or 100′.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. An MPO patch cord comprising:
fiber optic cordage possessing a plurality of optical fibers; and
a genderless MPO connector disposed at one end of said cordage presenting a mating face for mating said plurality of optical fibers to another MPO connector or MPO port.

2. The MPO patch cord according to claim 1, wherein said genderless MPO connector includes:
an alignment pin for entering a guide hole of the mating MPO connector or MPO port; and
a guide hole for receiving an alignment pin of the mating MPO connector or MPO port.

3. The MPO patch cord according to claim 2, further comprising:
a male MPO connector, having first and second alignment pins, disposed at an opposite end of said cordage.

4. The MPO patch cord according to claim 2, further comprising:
a female MPO connector, having first and second guide holes, disposed at an opposite end of said MPO cordage.

5. The MPO patch cord according to claim 2, wherein said genderless MPO connector is a first genderless MPO connector and further comprising:
a second genderless MPO connector disposed at an opposite end of said MPO cordage, wherein said second genderless MPO connector includes:
an alignment pin for entering a guide hole of another mating MPO connector or MPO port; and
a guide hole for receiving an alignment pin of the another mating MPO connector or MPO port.

6. The MPO patch cord according to claim 2, further comprising:
a fanout of individual fiber connectors disposed at an opposite end of said cordage.

7. The MPO patch cord according to claim 6, wherein said fanout of individual fiber connectors includes LC, SC, FC, MT-RJ and/or ST connectors.

8. The MPO patch cord according to claim 7, wherein said fanout of individual fiber connectors includes a plurality of duplex LC connectors.

9. A genderless MPO connector comprising:
a housing; and
a genderless MPO ferrule attached to said housing.

10. The genderless MPO connector according to claim 9, wherein said genderless MPO ferrule includes:
a termination side for mating with another MPO connector or an MPO port;
a generally flat ferrule face at said termination side of said ferrule;
an alignment pin extending away from said ferrule face;
a guide hole extending into said ferrule face; and
a plurality of fiber ends terminating at said ferrule face.

11. The genderless MPO connector according to claim 10, wherein said plurality of fiber ends are located in a single aligned row between said alignment pin and said guide hole.

12. The genderless MPO connector according to claim 10, wherein said plurality of fiber ends consist of eight fiber ends in a single row, twelve fiber ends in a single row, twenty-four fiber ends in two rows, forty-eight fiber ends in four rows, or seventy-two fiber ends in six rows.

13. The genderless MPO connector according to claim 10, further comprising:
a pin clamp located within said ferrule, wherein said alignment pin is connected to said pin clamp.

14. The genderless MPO connector according to claim 10, further comprising:
a strain relief boot being formed at a side of said ferrule opposite to said termination side of said ferrule, and wherein fibers exiting from said ferrule on the side opposite to said termination side pass through said strain relief boot.

15. A genderless MPO port comprising:
a housing; and
a genderless MPO ferrule attached to said housing.

16. The genderless MPO port according to claim 15, wherein said genderless MPO ferrule includes one alignment pin for entering a guide hole of an MPO connector and one guide hole for receiving an alignment pin of an MPO connector.

17. The genderless MPO port according to claim 15, wherein said genderless MPO ferrule includes:
a termination side to mate with an MPO connector;
a generally flat ferrule face at said termination side of said ferrule;
an alignment pin extending away from said ferrule face;
a guide hole extending into said ferrule face; and
a plurality of fiber ends terminating at said ferrule face.

18. The genderless MPO port according to claim 17, wherein said plurality of fiber ends are located in a single aligned row between said alignment pin and said guide hole.

19. The genderless MPO port according to claim 17, wherein said plurality of fiber ends consist of eight fiber ends in a single row, twelve fiber ends in a single row, twenty-four fiber ends in two rows, forty-eight fiber ends in four rows, or seventy-two fiber ends in six rows.

20. A genderless fiber optic connection comprising:
fiber optic cordage possessing a plurality of optical fibers;
a genderless MPO connector disposed at one end of said cordage presenting a mating face for mating said plurality of optical fibers to another MPO connector or MPO port, wherein said genderless MPO connector includes a first housing, and a first genderless MPO ferrule attached to said first housing, wherein said first genderless MPO ferrule includes said mating face; and
a genderless MPO port including a second housing, and a second genderless MPO ferrule attached to said second housing, wherein said second genderless MPO ferrule mates with said first genderless MPO ferrule when said genderless MPO connector is connected to said genderless MPO port.
